(19) United States
(12) Patent Application Publication
(10) Pub. No.: US 2009/0038886 A1
(43) Pub. Date: Feb. 12, 2009

(54) LADDER ASSEMBLY FORMED FROM INTEGRAL MATERIAL BLANK

(76) Inventors: Bruce G. Bastin, Starbuck, MN (US); Jade M. Abner, Benson, MN (US)

Correspondence Address: CNH AMERICA LLC, INTELLECTUAL PROPERTY LAW DEPARTMENT, 700 STATE STREET, RACINE, WI, 53404, US

(21) Appl. No.: 11/834,276

(22) Filed: Aug. 6, 2007

(51) Int. Cl. E06C 1/00

(52) U.S. Cl. 182/194

(57) ABSTRACT

A ladder is formed from an integral material blank having a pair of opposed side portions integrally joined to a central portion disposed between the side portions. The central portion includes a number of step portions spaced from one another along the length of the side portions. Each step portion includes a front edge integrally formed with the side sections and a step surface integrally formed with the front edge. The front edge of each step portion is joined to each of the pair of side portions and o the step surface along a pivot line that enables the side portions and the step surface to be manually bent with regard to the front edge when assembling the ladder assembly from the material blank.

### FIELD OF THE INVENTION

The invention relates to a ladder having a one-piece construction that is formed from a single sheet of a rigid material.

### BACKGROUND OF THE INVENTION

In order to enable an individual to move from one location to another location that is either elevated from or below a location at which the individual is positioned, oftentimes a ladder is utilized. Ladders are primarily formed from a pair of upright or vertical members between which extend multiple horizontal rungs. In use, the lower ends of the vertical numbers are braced on one surface on which the individual is located and extend upwardly or downwardly to the location to which the individual wishes to climb or descend. Once the ladder is in the proper position, an individual can climb or descend the ladder by placing the individuals hand and feet on the rungs to move upwardly or downwardly to the desired location.

As opposed to ladders which are not connected to any single structure, such that they can be moved about as necessary, in certain circumstances ladders are fixed to a particular object or structure that an individual requires assistance to reach, such as a large tractor or other motorized implement. Due to the size of the implement, and the consequent positioning of an operator's cab at a location in an elevated position on the implement, a ladder is required for an individual to ascend and reach the cab. Thus, a ladder constructed with the vertical members and the horizontal rungs is secured to the implement at a point where it can enable an individual to reach the operator's cab of the implement by utilizing the ladder. By securing the ladder to the implement, the ladder remains in the proper position on the implement, and cannot be misplaced, ensuring that the individual can reach the operator's cab.

For both the ladders constructed to be secured to an object or structure and those that are not, most often, the ladder is formed of multiple material pieces, more particularly the pair of upright members and the plurality of rungs extending between the upright members. These pieces can be secured to one another in any suitable manner, such as by using mechanical fasteners, when the ladder pieces are formed of wood, for example, or welding the pieces to one another, such as when the pieces are formed of a metal. In the case where the ladder is to be secured to an object or structure, the ladder structure can also include additional features the assist in securing the ladder to the structure. For example, brackets or other suitable members can be attached to the ladder to allow suitable fasteners to be engaged with both the ladder and the structure to hold the ladder on the structure. Alternatively, when the various components of the ladder are formed of a metal material, the ladder can be attached directly to the structure, such as by welding.

However, due to the multiple pieces utilized in prior art ladder structures, and the consequent connections required between the multiple pieces in order to form the desired ladder structure, the process for manufacturing a ladder requires numerous sequential steps utilizing the many components for the ladder structure in order to form the ladder with the desired structure. The time associated with this process for assembling the ladder and the number of components necessary to do so requires significant time and expense.

A need has thus arisen to provide an improved ladder assembly and an improved method of constructing a ladder that eliminates a number of the components previously required to construct a ladder. The need has also arisen to provide an improved ladder assembly that provides the same stability and utility as prior art ladder constructions. The need has also arisen to provide an improved method of constructing a ladder that reduces the number of components and consequent assembly steps required for the construction of the ladder. The need therefore has arisen to provide a simple, reliable, durable, and efficient ladder structure that can be quickly and easily assembled without the need for multiple components.

### SUMMARY OF THE INVENTION

The present invention provides a ladder assembly configured to be attached to a structure that is formed from a single component that has various part that can be folded or bent and secured to one another to form the ladder. The ladder assembly is formed from a sheet of a generally rigid material that is initially cut to form a ladder blank including the various components of the ladder assembly out of the piece of rigid material. The blank is then treated in certain locations at which various portions of the blank are to be folded or bent during the formation of the ladder to enable these portions of the blank to be bent more easily, while not sacrificing any of the inherent rigidity and stability of the material forming the ladder blank.

Furthermore, the present invention provides a method of constructing a ladder from the blank in which the various parts of the blank can be bent or displaced by hand to the proper locations for the ladder assembly. Once positioned in the proper locations, the portions of the ladder assembly can be secured to one another, such as by welding, to form the completed ladder.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 schematically illustrates a front elevation view of a ladder assembly blank constructed in accordance with the present invention.

FIG. 2 schematically illustrates an isometric view of a ladder assembly constructed from the blank of FIG. 1.

FIG. 3 is a cross-sectional view of the ladder assembly along line 3-3 in FIG. 2.

FIG. 4 schematically illustrates a front elevation view of the ladder assembly shown in FIG. 2.

FIG. 5 schematically illustrates a top plan view of the ladder assembly shown in FIG. 2.

### DETAILED DESCRIPTION OF THE PREFERRED EMBODIMENTS

A wide variety of ladder assemblies could be constructed in accordance with the invention defined by the claims. Hence, while preferred embodiments of the invention will now be described with reference to a ladder assembly constructed to be secured to a motorized implement, it should be understood that the invention is in no way so limited. The type of object or structure to which the ladder assembly can be secured can vary. In addition, the ladder assembly can be constructed for use independently from any structure to which the ladder is secured, such that the ladder functions similarly to prior art freestanding ladders.

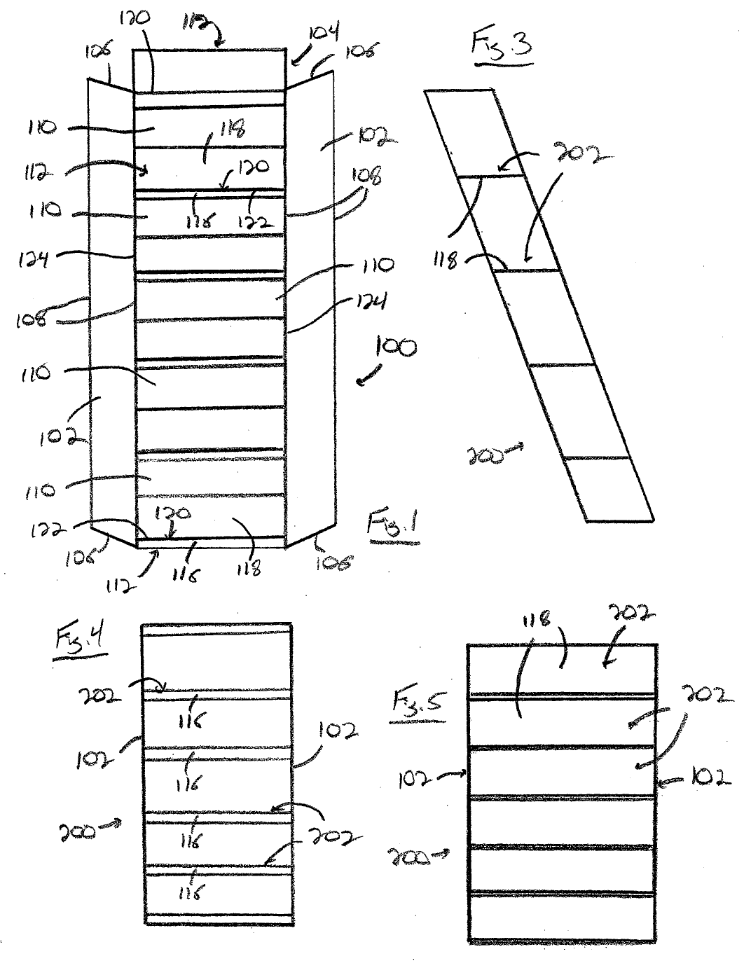

FIG. 1 illustrates a ladder assembly blank 100 formed in accordance with present invention from a suitable generally rigid material, such as a metal. The blank 100 includes a pair of side portions 102 integrally attached to opposite sides of a central portion 104. The side portions 102 are preferably trapezoidal in shape, with a pair of angled end edges 106 extending between side edges 108. However, it is also contemplated that the side portions 102 and the end edges 106 thereon can be formed to have other shapes as well, such as rectangular or square, depending on the desired shape for the ladder assembly 200 to be constructed from the blank 100.

The central portion 104 is generally rectangular in shape and includes a number of apertures 110 formed along the length of the central section 104. The apertures 110 extend completely across the central section 104, such that the apertures 110 are bounded on either end by the side portions 102. The apertures 110 are preferably evenly spaced along the length of the side portions 102, and are also preferably generally rectangular in shape.

Above and below the apertures 110, the central portion 104 includes a number of step portions 112 that are integrally attached between the side portions 102, and preferably evenly spaced along the length of the side portions 102. The number of step portions 112 formed in the blank 100 corresponds to the number of apertures 110, which is selected to provide a ladder assembly 200 formed from the blank 100 with the desired number of steps or rungs 202. Each step portion 112 includes a front edge 116 that is integrally connected at each end to the side portions 102, and a step surface 118 connected to the front edge 116. The front edge 116 is preferably dimensioned to be much shorter in length than the step surface 118, as the front edge 116 serves initially only to provide a point of attachment between the step portion 112 and the side portions 102. The step surface 118 is integrally formed with the front edge 116, but is separated from each of the side portions 102 along each side 114 of the step surface 118. At the point of attachment of the step surface 118 to the front edge 116, a pivot line 120 is formed to enable the step surface 118 to be pivoted or bent with respect to the front edge 116. While the pivot line 120 can be formed as a line of weakness in the material forming the blank 100 in any suitable manner, preferably, the pivot line 120 is formed by making a burn line 122, i.e., a line of heated and weakened material in the material forming the blank 100, along the pivot line 120 during formation of the blank 100 from the original material sheet. The burn line 122 is formed in a conventional manner, and, in conjunction with the separation of the step surface 118 from each of the side portions 102, enables the step surface 118 to be bent with regard to the front edge 116. Preferably, the burn line 122 is formed such that the step surface 118 can be bent by hand, without the need for any additional tools during the construction of the ladder assembly 200 from the blank 100.

Additionally, the points of connection between the side portions 102 and each of the front edges 116 formed along the central portion 104 are also formed with pivot lines 124, which can also be formed as burn lines 126 similarly to the burn lines 122 in the step portions 112. The presence of these lines 124 allows each side portion 102 to be folded or bent with regard to the front edges 116 of the step portions 112 in the central portion 104.

Referring again to FIG. 1, initially the blank 100 is formed from a sheet of the desired rigid material, such as a metal, and preferably steel. The side portions 102 and central portion 104 are subsequently formed out of the material sheet, such as by cutting the sheet at the desired location using any suitable cutting device (not shown). The cutting device is utilized to form the side portions 102 with the desired configuration for the end edges 106, and to form the apertures 110, front edges 116, and step surfaces 118 of the step portions 112 into the desired shape in the evenly spaced positions along the length of the side portions 102. Additionally, the cutting device can be used to separate the opposite sides 114 of the step surfaces 118 from the side portions 112, and optionally to form the pivot lines 120 and 124 between the front edge 116 and the step surface 118 of each step portion 112, and the side portions 102 and the front edges 116, respectively.

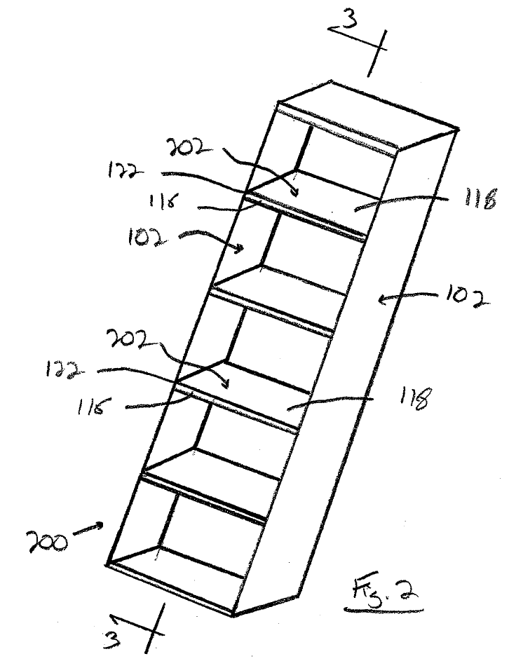

Once the blank 100 is completed, it can be stored for later use in forming a step assembly 200, or can be moved to a location for construction into the assembly 200, whether or not the assembly 200 is to be secured to a separate object or structure. When the blank 100 is to be assembled into the ladder assembly 200, as best shown in FIGS. 2-5, each of the side portions 102 and the step surfaces 118 are bent by hand with regard to those other portions of the blank 100 to which they are integrally connected. Further, both the side portions 102 and the step surfaces 118 are bent in the same direction, such that the side portions 102 are positioned to overlap the sides 114 of each step surface 118. In this position, the side potions 102 can be attached to the sides 114 of the step surfaces 118, such as by welding or other suitable means. When the step surfaces 118 are fixed to the side portions 102, the step surfaces 118 form a number of steps or rungs 202 for the assembly 200. Additionally, the topmost step surface 118 can be secured to the top end edge 106 of each side portion 102 in order to both form a top step 202 for the assembly 200, and to from a cover for the upper end edges 106 of each side portion 102. Once fully assembled, the ladder assembly 200 can be utilized in this form, or can be secured to another object or structure, such as to a motorized farm implement (not shown) to provide access to an elevated operator's cab on the implement.

In the configuration for the side portions 102 where the side portions 102 are trapezoidal in shape, the resultant configuration for the ladder assembly 200 is correspondingly angled. In alternative configurations, as discussed above, the shape of the side portions 102 can be made to be other than trapezoidal, such as rectangular, where the shape of the resulting ladder assembly 200 would be generally vertical. Also, the shape and number of the step portions 112 can be varied to provide a ladder assembly 200 formed from the blank 100 with any number of steps 202 as desired. Also, as opposed to being attached to the side portions 102 in a position that is perpendicular with regard to the front edge 116, the step surfaces 118 can be secured to each of the side portions 102 in alternative angular positions to vary the configuration of the ladder assembly 200.

Further, the step surfaces 118 can have varied shapes in addition to a rectangular shape as shown in the drawing figures. For example, the step surfaces 118 can be formed to be trapezoidal in shape, with the wide end (not shown) of the surfaces 118 disposed adjacent the corresponding front edge 116. In this configuration, the side portions 102 can be folded inwardly part perpendicular with respect to the front edges 116 into a position partially behind the front edges 116. In this position, when the side portions 102 are secured to the sides 114 of the step surfaces 118, the resulting ladder assembly 200 can have a trapezoidal cross-section.

In addition, one skilled in the art will recognize that the ladder assembly 200 present invention can include or be used with other suitable structures (not shown) that facilitate the attachment of the ladder assembly 200 to motorized implements or other structures, such as various brackets (not shown) or other attachment members (not shown) that can either be formed integrally with the blank 100, or that can be later attached prior to use of the ladder assembly 200.

Many changes and modifications could be made to the invention without departing from the spirit thereof. The scope of these changes will become apparent from the appended claims.

We claim:

1. A ladder assembly comprising:
a pair of side portions; and
at least one step portion integrally connected to each of the side portions, the at least one step portion including a front edge integrally connected to the side portions, and a step surface integrally connected to the front edge, and fixedly connected to the side portions.

2. The ladder assembly as recited in claim 1, wherein the step surface of the at least one step portion is welded to the side portions.

3. The ladder assembly as recited in claim 1, wherein the at least one step portion includes a pair of first pivot lines formed between the front edge and the pair of side portions that enable the side portions to be bent by hand with regard to the front edge.

4. The ladder assembly as recited in claim 1, wherein the at least one step portion includes a second pivot line formed between the front edge and the step surface that enables the step surface to be bent by hand with regard to the front edge.

5. The ladder assembly as recited in claim 4, wherein the pair of second pivot lines are formed as burn lines.

6. The ladder assembly as recited claim 1, wherein side portions are connected to opposite sides of the at least one step portion, and wherein the step surface of the at least one step portion is connected to the front edge between the side portions.

7. The ladder assembly as recited in claim 1, wherein the pair of side portions are generally trapezoidal in shape.

8. A blank for use in forming a unitary ladder assembly, the blank comprising:
a pair of side portions each having a pair of opposed end edges; and
a central portion disposed in a planar configuration with regard to the pair of side portions, the central portion including a number of step portions each having a front edge integrally connected to each of the side portions along a pair of first pivot lines, and a step surface integrally connected to the front edge along a second pivot line, wherein the number of step portions define apertures between adjacent step portions.

9. The ladder assembly blank as recited claim 8, wherein the blank is formed of a metal material.

10. The ladder assembly blank as recited in claim 9, wherein the pair of first pivot lines are formed as burn lines.

11. The ladder assembly blank as recited in claim 10, wherein the second pivot line is formed as a burn line.

12. A method of forming a ladder assembly from an integral material blank, the method comprising the acts of:
providing a material blank including a pair of side portions each having a pair of opposed end edges, and a central portion disposed in a planar configuration with regard to the pair of side portions, the central portion including a number of step portions each having a front edge integrally connected to each of the side portions along a pair of first pivot lines, and a step surface integrally connected to the front edge along a second pivot line;
bending the pair of side portions with respect to the front edge of each step portion;
bending the step surface of each step portion with regard to the front edge of each step portion; and
securing the side portions to opposed sides of the step surface or each step portion.

13. The method as recited in claim 12, wherein the act of bending the side portions with regard to the front edge of the step portion is performed manually.

14. The method as recited in claim 12, wherein the act of bending the step surface with regard to the front edge of the step portion is performed manually.

15. The method as recited in claim 12, wherein the material blank is formed of a metal material, and wherein the side portions are welded to the step surface of each step portion.
